(19) United States
(12) Patent Application Publication
(10) Pub. No.: US 2024/0065290 A1
(43) Pub. Date: Feb. 29, 2024

(54) METHOD FOR OBTAINING A PLANT-BASED SUBSTITUTE FOR COOKED ANIMAL FLESH

(71) Applicant: ALGAMA, Paris (FR)

(72) Inventor: Anne-Flore MONNET, Paris (FR)

(21) Appl. No.: 18/257,662

(22) PCT Filed: Dec. 22, 2021
(86) PCT No.: PCT/EP2021/087353

§ 371 Date: Jun. 15, 2023

(30) Foreign Application Priority Data
Dec. 22, 2020 (FR) FR2013965

(51) Int. Cl. A23J 3/22

(52) U.S. Cl. CPC A23J 3/227

(57) ABSTRACT

The present patent application relates to a method for obtaining a plant-based substitute for cooked animal flesh having a fibrous appearance. The aforementioned method improves the fibrous texture of the product, constituting a plant-based alternative to cooked animal flesh by carrying out a gelation step prior to an industrial extrusion technique. Said plant-based alternatives to cooked animal flesh are perfectly suitable for use in food preparations, for example in the preparation of chicken nuggets, fish croquettes, shrimp fritters, sausages or plant-based steaks.

The present patent application relates to a method for obtaining a plant-based substitute for cooked animal flesh having a fibrous appearance. The aforementioned method improves the fibrous texture of the product, constituting a plant-based alternative to cooked animal flesh by carrying out a gelation step prior to an industrial extrusion technique. Said plant-based alternatives to cooked animal flesh are perfectly suitable for use in food preparations, for example in the preparation of chicken nuggets, fish croquettes, shrimp fritters, sausages or plant-based steaks.

### PRIOR ART

There are currently methods for obtaining substitutes for cooked animal flesh by using extrusion. This makes it possible to obtain organoleptic properties that approximate animal versions, in particular in terms of flavor and odor, but also from a texture viewpoint on firmness and elasticity criteria.

The patent family WO2008034063A1 from SOLAE, LLC discloses a method for obtaining a preserved tuna substitute comprising a product based on plant proteins and fish flesh.

However, these methods have the disadvantage of allowing the production of a product whose fibrous appearance is limited, sometimes even nonexistent, even though this criterion is essential in the organoleptic profile of cooked animal flesh.

The Applicant has solved this technical problem of improving the fibrous texture by performing a gelling step prior to standard industrial extrusion techniques.

Thus, according to a first aspect, the invention relates to a method for obtaining a plant-based substitute for cooked animal flesh comprising the steps of:
a. Mixing water, food oil and plant proteins in a ratio of 8% to 20% plant proteins, 2% to 10% food oil and 70% to 90% water;
b. Homogenizing the product obtained in step a. at a pressure of between 100 and 600 bar, at a temperature between 50° C. and 90° C., at a speed of the liquid under pressure between 100 and 400 m·s−1;
c. Heating the product obtained in step b. for 10 to 30 min at a temperature of 70 to 95° C., stirring at 50 to 200 rpm;
d. Feeding the product obtained in step c. into an extruder at a rate of up to 25 kilograms per minute, the motor of the extruder feed being set to a speed of between 200 and 500 rpm, and the extruder temperature being set to between 50° C. and 200° C.,
e. Obtaining a substitute for cooked animal flesh.

“Plant-based substitute for cooked animal flesh” is understood to mean a product that makes it possible to replace cooked animal flesh while approximating its properties as closely as possible. In the context of the invention, said substitute has organoleptic properties that approximate animal versions, in particular in terms of flavor and odor, but also from a texture viewpoint on firmness and elasticity criteria enabling similarity to the fibrous texture of the animal flesh.

“Animal flesh” is understood to mean the meat as conventionally consumed, preferentially originating from the muscle part of animal bodies.

“Fibrous appearance” obtained by the method according to the invention is understood for example to mean the texture obtained during the cooking of a beef steak or a nugget. These meat fibers are in particular visible during the cutting of this product, and provide a visual appearance and taste that is characteristic of this type of product. The method according to the invention makes it possible to obtain a substitute having similar visual properties.

The term “product” is understood within the meaning of the invention in the method, to mean the various compositions or mixtures obtained at the various steps, which can be interchangeably called “product”, “substitute” or “mixture”.

The term “extruder” is understood to mean any type of commercially available extruder which can be single-screw or twin-screw. The screws mechanically grind the product while propelling it from the feed point to the outlet point. The outlet point is equipped with a nozzle that can take different shapes and sizes.

The combination of steps b. and c. allows gelation prior to the extrusion of the product, making it possible to improve the fibrous structure of the final product obtained.

Preferably according to the invention, the mixing step a. is carried out for 1 to 5 min at a speed of between 200 rpm and 800 rpm at a temperature of between 10° C. and 30° C.

Preferably according to the invention, the pressure applied in step b. is between 150 and 300 bar.

Preferably according to the invention, the temperature applied in step c. is between 80° C. and 95° C.

Preferably according to the invention, the method for obtaining a plant-based substitute for cooked animal flesh comprises a step b′. between steps b. and c., of mixing the product obtained in step b. with transglutaminase.

“Transglutaminase” means an enzyme catalyzing the formation of co-valent bonds within the proteins between free amine groups, for example those of lysine residues, and the gamma-carboxamide group of glutamine residues. The formation of these bonds makes it possible to reinforce the protein network obtained during gelation, and thus to promote the obtaining of a fibrous texture at the end of the extrusion step.

Preferably according to the invention, the mass of transglutaminase added is between 0.1% and 5% by mass of the product obtained in step b.

Even more preferably according to the invention, the mixing with transglutaminase is carried out for 60 to 240 min at a speed of 50 to 200 rpm and at a temperature of 30 to 60° C., preferably 30 to 40° C.

Preferably, the outlet nozzle of the extruder through which the product is ejected is rectangular and measures between 5 and 50 mm (millimeters) wide and 1 to 30 mm (millimeters) tall.

Depending on the food products one desires to form from the substitute obtained by the method, the size of the extrudate exiting the extruder may be different.

For example, for the formation of nuggets, the product obtained at the outlet of the extruder is cut into pieces of irregular shape whose longest length is 4 cm (centimeters). For the formation of fish croquettes, the product obtained at the outlet of the extruder is cut into slabs of 4 cm (centimeters) wide, 2 cm (centimeters) tall and 3 cm (centimeters) long, then re-ground to form a fine fibrous flesh.

Different methods well known to a person skilled in the art make it possible to obtain protein-rich extruded materials. In particular, mention may be made of the use of a cooking extruder, as presented in the materials and methods sections of the articles:
a. Philipp, C., Oey, I., Silcock, P., Beck, S. M., & Buckow, R. (2017). Impact protein content on physical and microstructural properties of extruded rice starch-pea protein snacks. Journal of Food Engineering, 212, 165-173.
b. Kristiawan, M., Micard, V., Maladira, P., Alchamieh, C., Maigret, J. E., Ré-guerre, A. L., . . . & Della Valle, G. (2018). Multi-scale structural changes of starch and proteins during pea flour extrusion. Food research international, 108, 203-215.
c. Jebalia, I., Maigret, J. E., Reguerre, A. L., Novales, B., Guessasma, S., Lourdin, D., . . . & Kristiawan, M. (2019). Morphology and mechanical behaviour of pea-based starch-protein composites obtained by extrusion. Carbohydrate polymers, 223, 115086.

Preferably according to the invention, said plant proteins consist of proteins from soy, pea, mung bean, broad bean, potato, wheat or microalgae, or a combination thereof.

Preferably according to the invention, said plant proteins consist of an extract composed of 50% to 98% proteins from soy, pea, mung bean, broad bean, potato, wheat or microalgae, or a combination thereof.

The term “microalgae” is intended to denote, according to the present invention, eukaryotic microalgae which are characterized by a nucleus, comprising for example chlorophytes, rhodophytes, haptophytes, bacillariophytes, eustigmatophytes, euglenophytes, thraustochytriaceae and dinophytes, said eukaryotic microalgae being commonly called “microalgae”, and prokaryotic microalgae, which do not have a nucleus, comprising cyanophytes, hereinafter referred to as “cyanobacteria”.

Preferably according to the invention, the eukaryotic microalgae are chosen from chlorophytes, preferably from Chlorella, Auxenochlorella, Dunaliella, Tetraselmis, Haematococcus, Scenedesmus; eustigmatophytes, preferably Nannochloropsis; euglenophytes, preferably Euglena; rhodophytes, preferably Porphyridium; bacillariophyceae, preferably Phaeodactylum and Odontella, and thraustochytriaceae, preferably Schizochytrium.

Even more preferably according to the invention, the microalgae used are chosen from Chlorella vulgaris, Chlorella prothotecoides, Dunaliella salina or Euglena gracilis, or a combination thereof.

Preferably according to the invention, the food oil is chosen from rapeseed oil, sunflower oil, palm oil, coconut oil, peanut oil, olive oil or flax oil, or a combination thereof.

Preferably according to the invention, in step c., acid is added in an amount of 0.3% to 10% by mass of the product obtained in step b.

Preferably, the acid is chosen from glucono-delta-lactone, citric acid or acetic acid, or a combination thereof.

Preferably according to the invention, in step c., salt is added in an amount of 0.2% to 1.5% by mass of the product obtained in step b.

Preferably, the salt is selected from sodium chloride, magnesium chloride, calcium chloride, potassium chloride, magnesium sulfate, calcium sulfate.

According to a preferred mode of the invention, the method according to the invention comprises the step of adding transglutaminase and/or adding salt in step c. and/or adding acid in step c.

More preferably, the method according to the invention comprises at least two of the elements selected from: the step of adding transglutaminase and/or adding salt in step c. and/or adding acid in step c.

According to one embodiment, said method for obtaining a plant-based substitute for cooked animal flesh comprising the steps of:
a. Mixing water, food oil and plant proteins in a ratio of 8% to 20% plant proteins, 2% to 10% food oil and 70% to 90% water for 1 to 5 min at a speed of between 200 rpm and 800 rpm and at a temperature of between 10° C. and 30° C.
b. Homogenizing the product obtained in step a. at a pressure of between 100 and 600 bar, preferably between 150 and 300 bar, at a temperature between 50° C. and 90° C., at a speed of the liquid under pressure between 100 and 400 m·s−1.
c. Mixing the product obtained in step b. 0.1% to 5% by mass of the product obtained in step b. of transglutaminase for 60 to 240 min at a speed of 50 to 200 rpm and at a temperature of 30 to 60° C., preferably between 30 and 40° C.,
d. Heating the product obtained in step c. for 10 to 30 min to a temperature between 80° C. and 95° c. while stirring at 50 to 200 rpm, adding salt in an amount of 0.2% to 1.5% by mass of the product obtained in step c. and acid in an amount of 0.3% to 10% by mass of the product obtained in step c.
e. Feeding the product obtained in step d. into an extruder at a rate of up to 25 kilograms per minute, the motor of the extruder feed being set to a speed of between 200 and 500 rpm, and the extruder temperature being set to between 50° C. and 200° C.,
f. Obtaining a substitute for cooked animal flesh.

According to a second aspect, the invention also relates to a plant-based substitute for cooked animal flesh as obtained according to the method of the invention.

Preferably according to the invention, said plant-based substitute for cooked animal flesh comprises:
a. 8% to 20% plant proteins;
b. 2% to 10% food oil;
c. 70% to 90% water.

Preferably according to the invention, said plant-based substitute for cooked animal flesh comprises:
a. 18% chlorella protein;
b. 5% rapeseed oil;
c. 77% water.

Preferably, said plant-based substitute for cooked animal flesh comprises:
a. 20% soy protein;
b. 8% sunflower oil;
c. 72% water.

Example composition according to the invention:

TABLE 1
Composition 1 (%)

| | |
|---|---|
| Chlorella protein | 18% |
| Rapeseed oil | 5% |
| Water | 77% |

Example composition according to the invention:

TABLE 2
Composition 2 (%)

| | |
|---|---|
| Soy protein | 20% |
| Sunflower oil | 8% |
| Water | 72% |

According to a third aspect, the invention also relates to the use of the plant-based substitute for cooked animal flesh as obtained by the aforementioned method or the plant-based substitute for cooked animal flesh in food preparations.

Preferably, said food preparations comprise chicken nuggets, fish croquettes, shrimp fritters, sausages or plant-based steaks.

### EXAMPLES

### Example 1: Preparation of Plant-Based Substitutes for Cooked Animal Flesh According to the Invention, and Formation of Chicken Nuggets

Mix water, food oil and plant proteins in a ratio of 15% plant proteins, 5% food oil and 80% water for 4 min at a speed of 600 rpm and at a temperature between 20° C.

Place the product obtained in a high-pressure homogenizer, at a pressure of 200 bar, at a temperature of between 50° C. and 90° C., at a speed of the liquid under pressure between 100 and 400 m·s−1.

Heat the mixture obtained for 20 min at a temperature of 88° C. while stirring at 100 rpm.

The product obtained is inserted into a twin-screw extruder at a maxi-mum speed of 12 kilograms per minute. The motor of the extruder feed screws is set to a speed of 300 rpm. The extruder temperature is set at 124° C. The outlet nozzle of the extruder through which the product is ejected is rectangular and measures 30 millimeters width and 20 millimeters tall.

The product obtained at the extruder outlet is cut into pieces of irregular shape, the longest length of which is 4 cm (centimeters), forming the nuggets.

### Example 2: Comparative Sensory Analysis Test

From the plant-based substitute for cooked animal flesh prepared in example 1, a sensory analysis test is carried out that makes it possible to com-pare the degree of fibrosity of said substitute to that of a chicken nugget substitute found on the market.

The degree of fibrosity is defined according to two sensory criteria: the fibrous appearance evaluated visually and the mouthfeel of fibrous texture.

A portion of 40 g (equivalent to two nuggets) of said plant-based chicken nugget substitute as prepared in example 1 is prepared (called sample “A”).

A portion of 40 g (equivalent to two nuggets) of a chicken nugget substitute found on the market is prepared (called sample “B”).

Each member of a panel of 60 consumers receives a sample A and a sample B.

The samples are presented in a random order to each consumer. Possible orders are: AB, BA.

Each person is asked to taste the first sample and to score the fibrous appearance as visually evaluated and the fibrous texture mouthfeel on a scale of 1 to 10 for this sample.

Each person is then asked to rinse their mouth with water and then to score the fibrous appearance as visually evaluated and the fibrous texture mouthfeel on a scale of 1 to 10 for the second sample.

For the statistical processing of the results, the average and standard deviation of the visually evaluated fibrous appearance score and the fibrous texture mouthfeel score are calculated for samples A and B.

An analysis of variance with multiple comparison of the averages by Dunnett's test is carried out in order to determine whether the fibrous appearance scores as visually evaluated and of the fiber texture mouthfeel of samples A and B are significantly different, within a tolerance of 5%.

The average fibrous appearance scores as visually evaluated and fibrous texture mouthfeel of sample A are significantly greater than the average scores of sample B.

It is concluded that said substitute constituting a plant-based alternative to cooked animal flesh prepared in example 1 has a degree of fibrosity greater than that of the chicken nugget substitute found on the market.

### Example 3: Preparation of Plant-Based Substitutes for Cooked Animal Flesh According to the Invention, Comprising a Step of Adding Transglutaminase, and Formation of Chicken Nuggets

Mix water, food oil and plant proteins in a ratio of 15% plant proteins, 5% food oil and 80% water for 4 min at a speed of 600 rpm and at a temperature between 20° C.

Place the product obtained in a high-pressure homogenizer, at a pressure of 200 bar, at a temperature of between 50° C. and 90° C., at a speed of the liquid under pressure between 100 and 400 m·s−1.

Mix transglutaminase into the product obtained in the amount of 2% by mass of the product for 60 min at a speed of 50 to 200 rpm and at a temperature of 40 to 50° C.

Heat the mixture obtained for 20 min at a temperature of 88° C. while stirring at 100 rpm.

The product obtained is inserted into a twin-screw extruder at a maxi-mum speed of 12 kilograms per minute. The motor of the extruder feed screws is set to a speed of 300 rpm. The extruder temperature is set at 124° C. The outlet nozzle of the extruder through which the product is ejected is rectangular and measures 30 millimeters width and 20 millimeters tall.

The product obtained at the extruder outlet is cut into pieces of irregular shape, the longest length of which is 4 cm (centimeters), forming the nuggets.

1. A method for obtaining a substitute for cooked animal flesh comprising the steps of:
a. Mixing water, food oil and plant proteins in a ratio of 8% to 20% plant proteins, 2% to 10% food oil and 70% to 90% water;
b. Homogenizing the product obtained in step a. at a pressure of between 100 and 600 bar, at a temperature between 50° C. and 90° C., at a speed of the liquid under pressure between 100 and 400 m·s−1;
c. Heating the product obtained in step b. for 10 to 30 min at a temperature of 70 to 95° C., stirring at 50 to 200 rpm;
d. Feeding the product obtained in step c. into an extruder at a rate of up to 25 kilograms per minute, the motor of the extruder feed being set to a speed of between 200 and 500 rpm, and the extruder temperature being set to between 50° C. and 200° C.;
e. Obtaining a substitute for cooked animal flesh.

2. The method for obtaining a plant-based substitute for cooked animal flesh according to claim 1, characterized in that the mixing step a. is carried out for 1 to 5 min at a speed of between 200 rpm and 800 rpm at a temperature of between 10° C. and 30° C.

3. The method for obtaining a plant-based substitute for cooked animal flesh according to claim 1, characterized in that the pressure applied in step b. is between 150 and 300 bar.

4. The method for obtaining a plant-based substitute for cooked animal flesh according to claim 1, characterized in that the temperature applied in step c. is between 80° C. and 95° C.

5. The method for obtaining a plant-based substitute for cooked animal flesh according to claim 1, comprising a step b′. between steps b. and c., of mixing the product obtained in step b. with transglutaminase.

6. The method for obtaining a plant-based substitute for cooked animal flesh according to claim 5, characterized in that the mass of transglutaminase is between 0.1% and 5% by mass of the product obtained in step b.

7. The method for obtaining a plant-based substitute for cooked animal flesh according to claim 5, characterized in that the mixing with transglutaminase is carried out for 60 to 240 min at a speed of 50 to 200 rpm and at a temperature of 30 to 60° C., preferably 30 to 40° C.

8. The method for obtaining a plant-based substitute for cooked animal flesh according to claim 1, characterized in that the outlet nozzle of the extruder through which the product is ejected is rectangular and measures between and 50 mm wide and 1 to 30 mm tall.

9. The method for obtaining a plant-based substitute for cooked animal flesh according to claim 1, characterized in that said plant proteins consist of an extract composed of 50% to 98% proteins from soy, pea, mung bean, broad bean, potato, wheat or microalgae, or a combination thereof.

10. The method for obtaining a plant-based substitute for cooked animal flesh according to claim 9, characterized in that the proteins from microalgae come from Chlorella vulgaris, Chlorella prothotecoides, Dunaliella salina or Euglena gracilis, or a combination thereof.

11. The method for obtaining a plant-based substitute for cooked animal flesh according to claim 1, characterized in that the food oil is chosen from rapeseed oil, sunflower oil, palm oil, coconut oil, peanut oil, olive oil or flax oil, or a combination thereof.

12. A plant-based substitute for cooked animal flesh as obtained by the method according to claim 1, comprising:
Between 8% and 20% plant proteins;
Between 2% and 10% food oil;
Between 70% and 90% water.

13. The plant-based substitute for cooked animal flesh according to the claim 12, comprising:
18% chlorella protein;
5% rapeseed oil;
77% water.

14. A substitute constituting a plant-based alternative to cooked animal flesh according to claim 12, comprising:
20% soy protein;
8% sunflower oil;
72% water.

15. A use of the plant-based substitute for cooked animal flesh as obtained by the method according to claim 1 or of the plant-based substitute for cooked animal flesh, in food preparations, preferably in the preparation of fish croquettes, chicken nuggets, shrimp fritters, sausages or plant-based steaks.
